(19) United States
(12) Patent Application Publication
(10) Pub. No.: US 2024/0333530 A1
(43) Pub. Date: Oct. 3, 2024

(54) IMAGE FORMING APPARATUS, PROCESSING METHOD, NON-TRANSITORY COMPUTER-READABLE STORAGE MEDIUM STORING PROGRAM, AND SERVER

(71) Applicant: SEIKO EPSON CORPORATION, Tokyo (JP)

(72) Inventor: Takaaki TANIGUCHI, SHIOJIRI-SHI (JP)

(21) Appl. No.: 18/614,867

(22) Filed: Mar. 25, 2024

(30) Foreign Application Priority Data
Mar. 28, 2023 (JP) 2023-051871

(51) Int. Cl. H04L 9/32

(52) U.S. Cl. CPC H04L 9/3268

(57) ABSTRACT

An image forming apparatus includes a communication unit configured to communicate with a first server that periodically updates a server certificate SC and a second server that manages registration information in which an IP address and host name information are associated with each other, and a processor. The processor 120 acquires the server certificate SC created based on the host name information from the first server 200-1 via the communication unit 110, and transmits the host name information and the IP address of the image forming apparatus 100 to the second server 200-2 via the communication unit 110. When receiving a communication request packet from the terminal apparatus 300 that acquires the IP address based on the registration information, the processor 120 performs HTTPS communication with the terminal apparatus 300 using the server certificate SC.

The present application is based on, and claims priority from JP Application Serial Number 2023-051871, filed Mar. 28, 2023, the disclosure of which is hereby incorporated by reference herein in its entirety.

### BACKGROUND

### 1. Technical Field

The present disclosure relates to an image forming apparatus, a processing method, a non-transitory computer-readable storage medium storing a program, a server, and the like.

### 2. Related Art

In related art, a method for performing communication using a server certificate between a terminal apparatus and a server is known. WO 2016/151824 discloses a method of acquiring a server certificate based on an IP address of a server.

WO 2016/151824 is an example of the related art.

### SUMMARY

The server certificate is also required in communication between a terminal apparatus and a Web server built in an image forming apparatus. Since the server certificate has a certain expiration date, a user has a burden of managing the expiration date of the server certificate and update the server certificate, resulting in insufficiency in convenience of the image forming apparatus.

An aspect of the present disclosure relates to an image forming apparatus including: a communication unit configured to communicate with a first server that periodically updates a server certificate and a second server that manages registration information in which an IP address and host name information are associated with each other; and a processing unit. The processing unit acquires the server certificate created based on the host name information from the first server via the communication unit, transmits the host name information and the IP address of the image forming apparatus to the second server via the communication unit, and when receiving a communication request packet from a terminal apparatus that acquires the IP address based on the registration information, performs HTTPS communication with the terminal apparatus using the server certificate.

Another aspect of the present disclosure relates to a processing method including: processing of communicating with a first server that periodically updates a server certificate and a second server that manages registration information in which an IP address and host name information are associated with each other; processing of acquiring the server certificate created based on the host name information from the first server; processing of transmitting the host name information and the IP address of the image forming apparatus to the second server; and processing of, when receiving a communication request packet from a terminal apparatus that acquires the IP address based on the registration information, performing HTTPS communication with the terminal apparatus using the server certificate.

Still another aspect of the present disclosure relates to a non-transitory computer-readable storage medium storing a program causing a computer to function as a communication unit configured to communicate with a first server that periodically updates a server certificate and a second server that manages registration information in which an IP address and host name information are associated with each other, and a processing unit. The processing unit acquires the server certificate created based on the host name information from the first server via the communication unit, transmits the host name information and the IP address of the image forming apparatus to the second server via the communication unit, and when receiving a communication request packet from a terminal apparatus that acquires the IP address based on the registration information, performs HTTPS communication with the terminal apparatus using the server certificate.

Still another aspect of the present disclosure relates to a server including: a server communication unit configured to communicate with an image forming apparatus; a server processing unit configured to manage registration information in which an IP address of the image forming apparatus and host name information are associated with each other. The server processing unit receives the host name information and the IP address via the server communication unit from the image forming apparatus that acquires a server certificate created based on the host name information, and manages the registration information based on the received host name information and IP address.

### BRIEF DESCRIPTION OF THE DRAWINGS

FIG. 1 is a diagram illustrating a configuration example of a system including an image forming apparatus.

FIG. 2 is a flowchart illustrating an example of processing executed by the image forming apparatus.

FIG. 3 is a diagram illustrating another configuration example of the system including the image forming apparatus.

FIG. 4 is a diagram illustrating an example of a flow of processing according to the embodiment.

FIG. 5 is a diagram illustrating a more detailed configuration example of the image forming apparatus.

FIG. 6 illustrates a server certificate and registration information.

FIG. 7 is a diagram illustrating another example of the flow of processing according to the embodiment.

FIG. 8 is a flowchart illustrating an example of processing executed by a second server.

FIG. 9 is a diagram illustrating another configuration example of the system including the image forming apparatus.

### DESCRIPTION OF EMBODIMENTS

Hereinafter, the embodiment will be described. The embodiment to be described below do not unduly limit contents of the present disclosure described in the claims. Not all configurations described in the embodiment are necessarily essential components of the present disclosure.

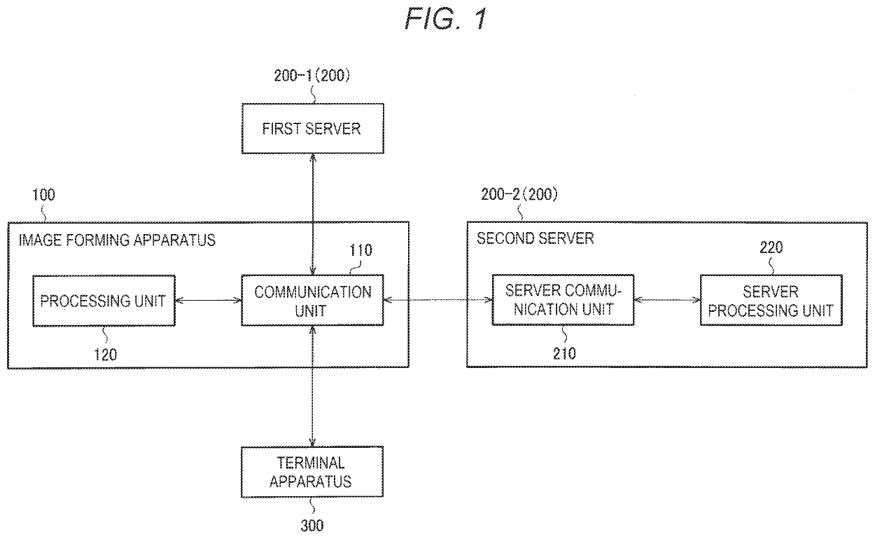

FIG. 1 is a block diagram illustrating a configuration example of a system including an image forming apparatus 100 according to the embodiment. The image forming apparatus 100 according to the embodiment is, for example, a printer, and may also be a scanner, a personal computer, a wearable device, a biological information measurement device, a robot, a video device, a physical quantity measurement device, or the like. The printer here may be, for example, an inkjet printer, and may also be, for example a dot impact printer, a thermal transfer printer, a laser printer, or a label printer. The wearable device refers to a smart watch, an activity tracker, or the like. The biological information measurement device refers to a pulse meter, a pedometer, or the like. The video device refers to a camera, a projector, or the like. The physical quantity measurement device refers to a thermometer, a weight scale, or the like. The printer herein includes a multifunction peripheral. The multifunction peripheral refers to a printer having functions other than a printer function, and the functions other than the printer function include a copy function, a fax function, a scanner function, and the like, and may also include other functions.

The system in FIG. 1 includes at least a first server 200-1, a second server 200-2, and a terminal apparatus 300 in addition to the image forming apparatus 100. The image forming apparatus 100 includes a communication unit 110 and a processing unit 120.

The communication unit 110 is a communication interface that communicates with the first server 200-1, the second server 200-2, and the terminal apparatus 300 and performs communication according to a predetermined communication standard. The communication unit 110 may be implemented by, for example, communication hardware such as a communication application specific integrated circuit (ASIC) or a communication processor, and communication firmware. In the embodiment, the communication unit 110 can transmit information to an external apparatus such as the image forming apparatus 100 or receive information from the external apparatus when the processing unit 120 to be described later performs communication control processing such as information transmission processing or reception processing on the communication unit 110. That is, the communication unit 110 includes hardware, communication firmware, and the like corresponding to desired wireless communication standards. The predetermined communication standard is, for example, wireless communication based on Wi-Fi (registered trademark), and the communication unit 110 performs wireless communication based on a predetermined connection mode of Wi-Fi. The predetermined connection mode is, for example, an infrastructure mode. That is, the image forming apparatus 100 communicates with the first server 200-1, the second server 200-2, and the terminal apparatus 300 via an external access point (not illustrated).

The processing unit 120 executes processing of units of the image forming apparatus 100. The processing unit 120 includes the following hardware. The hardware includes a circuit for processing a digital signal, and may further include a circuit for processing an analog signal. For example, the hardware may include one or more circuit apparatuses mounted on a circuit board and one or more circuit elements. Examples of the one or more circuit apparatuses include an integrated circuit (IC) and a field-programmable gate array (FPGA). The one or more circuit elements include, for example, resistors or capacitors. The processing unit 120 is implemented by including at least one of the following processors. The processing unit 120 includes a memory 130 that stores information not illustrated in FIG. 1, and a processor that operates based on the information stored in the memory 130. The information includes, for example, a program and various data. The processor includes hardware. Various processors such as a central processing unit (CPU), a graphics processing unit (GPU), and a digital signal processor (DSP) can be used as the processor. The memory 130 may be a semiconductor memory such as a static random access memory (SRAM) or a dynamic random access memory (DRAM), a register, a magnetic storage apparatus such as a hard disk drive (HDD), or an optical storage apparatus such as an optical disk apparatus. For example, the memory stores computer-readable instructions, and when the processor executes the instructions, some or all of the functions of the units of the image forming apparatus 100 are implemented as processing. The instructions here may be instructions of an instruction set constituting a program, or instructions instructing a hardware circuit of a processor to operate.

Although one image forming apparatus 100 is illustrated in FIG. 1, a plurality of image forming apparatuses 100 may be coupled to the first server 200-1, the second server 200-2, and the like.

The terminal apparatus 300 is, for example, a portable information terminal such as a smartphone, and may also be a personal computer or the like. Similarly to the communication unit 110 of the image forming apparatus 100, the terminal apparatus 300 includes a communication interface corresponding to a predetermined communication standard, and communicates with the image forming apparatus 100 according to a predetermined communication protocol (not illustrated). Although not illustrated, the terminal apparatus 300 includes a processor similar to the processing unit 120 of the image forming apparatus 100, and controls units of the terminal apparatus 300. The terminal apparatus 300 may further include, for example, a storage unit, a display unit, and an operation unit, and the operation unit may be hardware integrated with the display unit, for example, using a touch panel. In the following description, transmission and reception of data by the processor of the terminal apparatus 300 via the communication interface is simply referred to as transmission and reception of data by the terminal apparatus 300.

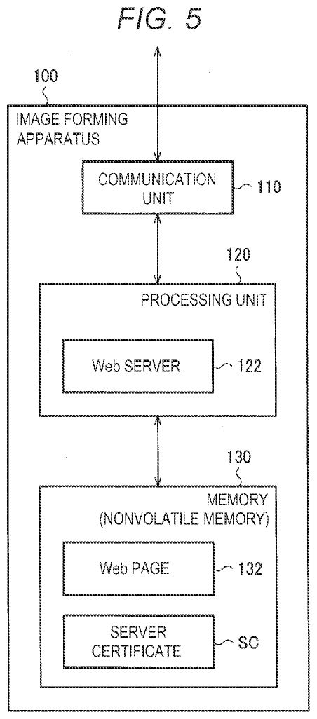

The terminal may perform a function of a Web browser as software. That is, the processor of the terminal apparatus 300 may function as the Web browser by reading a program related to the Web browser from a storage unit (not illustrated) and executing input and output processing, display processing, and the like. Accordingly, for example, a user of the terminal apparatus 300 can access a Web server 122 of the image forming apparatus 100 to be described later with reference to FIG. 5 via the Web browser and browse a Web page 132 to be described later with reference to FIG. 5. That is, a client server system in which the image forming apparatus 100 is a server and the terminal apparatus 300 is a client is established between the image forming apparatus 100 and the terminal apparatus 300. In this case, the predetermined communication protocol is a communication protocol corresponding to browsing the Web page 132, and is, for example, a hyper text transfer protocol (HTTP). The HTTP may include a hyper text transfer protocol secure (HTTPS). Accordingly, encrypted communication can be performed between the image forming apparatus 100 and the terminal apparatus 300.

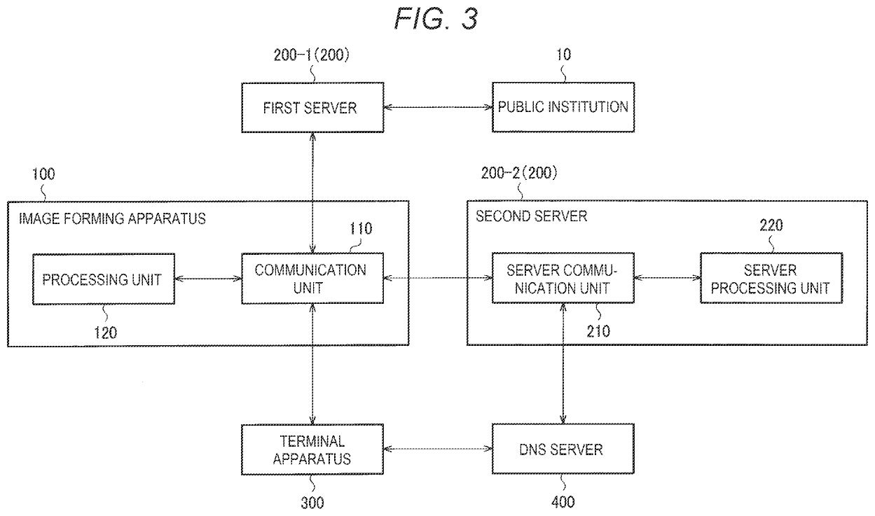

When performing communication based on the HTTPS communication protocol, it is necessary to store a server certificate SC capable of verifying a root certificate of the terminal apparatus 300 as the client in the image forming apparatus 100 as the server. In the following description, “communication based on the HTTPS communication protocol” may be abbreviated as “HTTPS communication” as appropriate. For example, as will be described later with reference to FIG. 5, the server certificate SC needs to be stored in the memory 130 of the image forming apparatus 100. The server certificate SC includes a signature of a public institution 10 to be described later with reference to FIG. 3, a public key necessary for encryption of communication, and the like. In order to verify the root certificate of the terminal apparatus 300 as the client, it is required that an expiration date of the server certificate SC is not reached, that host name information on or an IP address of the image forming apparatus 100 as the server is recorded in a subject alternative name (SAN) that is an information area provided in the server certificate SC, and the like. That is, the server certificate SC according to the embodiment is created based on the host name information by the public institution 10 to be described later.

The first server 200-1 periodically updates the server certificate SC. Specifically, for example, by coupling to the public institution 10 to be described later and periodically transmitting a request packet (not illustrated) to the public institution 10, the updated server certificate SC is acquired from the public institution 10. In the following description, transmission of the request packet may be referred to as transmission of a request or requesting. The updated server certificate SC is set to an expiration date extended by a prescribed period from the expiration date of the server certificate SC before update. That is, although not illustrated, the first server 200-1 includes a communication interface similar to the communication unit 110 and a processor similar to the processing unit 120. The processor communicates with the image forming apparatus 100, the public institution 10 to be described later, and the like by controlling the communication interface. In the following description, transmission and reception of data by the processor of the first server 200-1 via the communication interface is simply referred to as transmission and reception of data by the first server 200-1.

The second server 200-2 includes a server communication unit 210 and a server processing unit 220. The server communication unit 210 is a communication interface similar to the communication unit 110 described above, and communicates with the communication unit 110 of the image forming apparatus 100. The server processing unit 220 controls units of the second server 200-2 such as the server communication unit 210. Although details will be described later, the second server 200-2 manages registration information in which the IP address of the image forming apparatus 100 and the host name information are associated with each other.

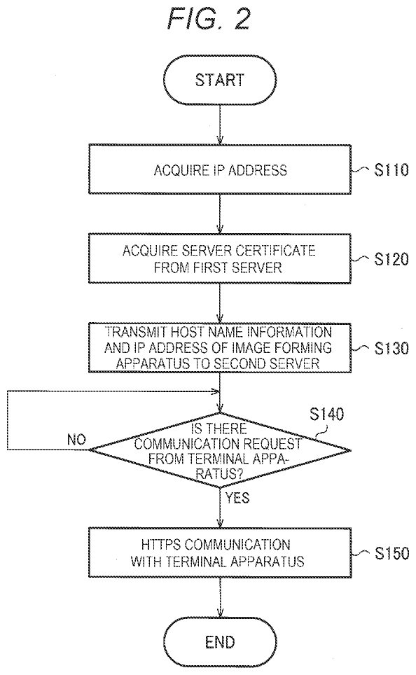

An example of processing executed by the image forming apparatus 100 according to the embodiment will be described with reference to a flowchart in FIG. 2. The processing in FIG. 2 is executed at a predetermined timing. The predetermined timing will be described later. The processing unit 120 acquires an IP address (step S110). For example, the image forming apparatus 100 can use private IP addresses in a certain range. Then, the processing unit 120 executes processing of selecting any IP address from the private IP addresses in the certain range.

Thereafter, the processing unit 120 acquires the server certificate SC from the first server 200-1 (step S120). For example, the processing unit 120 transmits, to the first server 200-1, a request packet regarding whether the server certificate SC is updated. When determining that the updated server certificate SC is acquired, the first server 200-1 transmits a response packet including the server certificate SC to the processing unit 120. Accordingly, the processing unit 120 acquires the server certificate SC updated in step S120. When determining that the updated server certificate SC is not acquired, the first server 200-1 may transmit a response packet including the latest server certificate SC to the processing unit 120 as formal processing, or may transmit, to the processing unit 120, a response packet including data indicating that the updated server certificate SC is not acquired.

Thereafter, the processing unit 120 transmits the acquired IP address and host name information on the image forming apparatus 100 to the second server 200-2 (step S130). Accordingly, the server processing unit 220 of the second server 200-2 receives the IP address and the host name information, and stores the IP address and the host name information association with each other as registration information in the server memory 230 (not illustrated in FIG. 1). That is, the server processing unit 220 according to the embodiment receives the host name information and the IP address via the server communication unit 210 from the image forming apparatus 100 that acquires the server certificate SC created based on the host name information, and manages the registration information based on the received host name information and IP address. As will be described later, the server processing unit 220 may further associate time information received as registration information.

Thereafter, the processing unit 120 executes processing of determining whether there is a request from the terminal apparatus 300 (step S140). That is, the processing unit 120 determines whether there is an access to the Web server 122 to be described later by the Web browser of the terminal apparatus 300. For example, when the user of the terminal apparatus 300 inputs the host name information on the Web browser, the user acquires the IP address corresponding to the host name information from the second server 200-2, and the Web browser accesses the image forming apparatus 100 corresponding to the IP address. That is, the second server 200-2 and a DNS server 400 may be separately provided as will be described later, or the second server 200-2 may further function as the DNS server 400. When determining that there is a request from the terminal apparatus 300 (YES in step S140), the processing unit 120 performs HTTPS communication with the terminal apparatus 300 (step S150). Since the server certificate SC is updated, an error indicating that an expiration date of the server certificate SC is reached is not displayed on the Web browser of the terminal apparatus 300. On the other hand, when determining that there is no request from the terminal apparatus 300 (NO in step S140), the processing unit 120 executes step S140 again.

As described above, the image forming apparatus 100 according to the embodiment includes the communication unit 110 that communicates with the first server 200-1 that periodically updates the server certificate SC and the second server 200-2 that manages registration information in which an IP address and host name information are associated with each other, and the processing unit 120. The processing unit 120 acquires the server certificate SC created based on the host name information from the first server 200-1 via the communication unit 110, and transmits the host name information and the IP address of the image forming apparatus 100 to the second server 200-2 via the communication unit 110. When receiving a communication request packet from the terminal apparatus 300 that acquires the IP address based on the registration information, the processing unit 120 performs HTTPS communication with the terminal apparatus 300 using the server certificate SC.

In this way, the image forming apparatus 100 according to the embodiment can communicate with the first server 200-1, the second server 200-2, and the terminal apparatus 300 by including the communication unit 110. Accordingly, since the image forming apparatus 100 communicates with the first server 200-1 that periodically updates the server certificate SC, the image forming apparatus 100 can acquire the updated server certificate SC. Since the image forming apparatus 100 communicates with the second server 200-2, the image forming apparatus 100 can transmit the host name information and the IP address of the image forming apparatus 100 to the second server 200-2. Accordingly, a request from the terminal apparatus 300 that acquires the IP address associated with the host name information from the second server 200-2 can be received. Accordingly, the image forming apparatus 100 that acquires the updated server certificate SC can perform HTTPS communication with the terminal apparatus 300.

When the expiration date of the server certificate SC is reached, HTTPS communication cannot be performed between the image forming apparatus 100 and the terminal apparatus 300, the user of the terminal apparatus 300 needs to manually update the server certificate SC, resulting in insufficiency in convenience of the image forming apparatus 100. In this regard, by applying a method according to the embodiment, the image forming apparatus 100 that acquires the updated server certificate SC receives the request from the terminal apparatus 300, and thus HTTPS communication can be performed between the image forming apparatus 100 and the terminal apparatus 300 without a burden on the user to manage the expiration date of the server certificate SC. Accordingly, convenience of the image forming apparatus 100 can be improved.

The method according to the embodiment may be implemented as a processing method. That is, the processing method according to the embodiment includes processing of communicating with the first server 200-1 that periodically updates the server certificate SC and the second server 200-2 that manages registration information in which an IP address and host name information are associated with each other, and processing of acquiring the server certificate SC created based on the host name information from the first server 200-1. The processing method according to the embodiment further includes processing of transmitting the host name information and the IP address of the image forming apparatus 100 to the second server 200-2, and processing of, when receiving a communication request packet from the terminal apparatus 300 that acquires the IP address based on the registration information, performing HTTPS communication with the terminal apparatus 300 using the server certificate SC. By doing so, the same effects as described above can be attained.

The method according to the embodiment may be implemented as a program. That is, the program according to the embodiment causes a computer to function as the communication unit 110 that communicates with the first server 200-1 that periodically updates the server certificate SC and the second server 200-2 that manages registration information in which an IP address and host name information are associated with each other, and the processing unit 120. The processing unit 120 acquires the server certificate SC created based on the host name information from the first server 200-1 via the communication unit 110, and transmits the host name information and the IP address of the image forming apparatus 100 to the second server 200-2 via the communication unit 110. When receiving a communication request packet from the terminal apparatus 300 that acquires the IP address based on the registration information, the processing unit 120 performs HTTPS communication with the terminal apparatus 300 using the server certificate SC. By doing so, the same effects as described above can be attained.

The method according to the embodiment is not limited to the above, and various modifications can be made. For example, the system including the image forming apparatus 100 may be configured as illustrated in FIG. 3. FIG. 3 is different from FIG. 1 in that the first server 200-1 is further coupled to the public institution 10 to be described later, and the second server 200-2 and the terminal apparatus 300 are further coupled to the DNS server 400. By doing so, servers can be optimally managed. For example, the first server 200-1 and the second server 200-2 are arranged on a network of a manufacturer of the image forming apparatus 100 and managed by the manufacturer, the DNS server 400 is arranged on an external cloud server, and the DNS server 400 is managed by an operator of the cloud server, whereby a management burden and the like can be optimized.

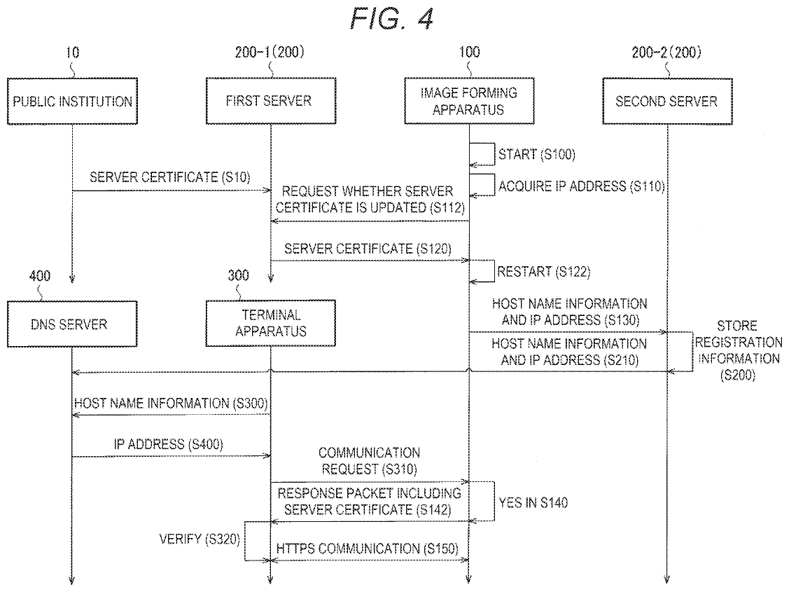

An example of a processing flow of the method according to the embodiment will be described in more detail with reference to FIG. 4. Although details will be described later, in the image forming apparatus 100 according to the embodiment, the processing unit 120 updates the server certificate SC at a predetermined timing. By doing so, a burden on the user to manually update the server certificate SC can be eliminated. In the example illustrated in FIG. 4, as a predetermined timing, the image forming apparatus 100 acquires an IP address at a timing when the image forming apparatus 100 is started. A vertical direction on the paper surface is a time axis, and time passes downward, but a length of an arrow or the like does not indicate a specific length of time.

The first server 200-1 acquires the server certificate SC from the public institution 10 (step S10). The public institution 10 is also called a public certificate authority or the like. For example, the manufacturer of the image forming apparatus 100 applies to the public institution 10 to issue the server certificate SC. Then, the public institution 10 examines a domain name, organization information, existence, and the like of the manufacturer that is an applicant from a registration copy or the like, and issues the server certificate SC based on the examination result. In this way, the server certificate SC according to the embodiment is an organization authentication type certificate certifying that the Web server 122 of the image forming apparatus 100 to be described later exists. A wildcard certificate to be described later can be used as the organization authentication type certificate.

The processing unit 120 is powered on and started (step S100), acquires the IP address (step S110), and then transmits a request to the first server 200-1 regarding whether the server certificate SC is updated (step S112). In this way, in the image forming apparatus 100 according to the embodiment, the processing unit 120 transmits a request packet regarding whether the server certificate SC is updated to the first server 200-1 via the communication unit 110 at a timing when the image forming apparatus 100 is started and the IP address of the image forming apparatus 100 is acquired. By doing so, the server certificate SC can be updated at the timing when the image forming apparatus 100 is started. For example, when it is desired that the image forming apparatus 100 operates continuously for a long time, it is more convenient to download the updated server certificate SC at the time of starting the image forming apparatus 100 and execute restarting (step S112) to be described later. This is because operation continuity is lost by executing restarting (step S112).

Thereafter, the processing unit 120 acquires the updated server certificate SC from the first server 200-1 (step S120). Step S120 will be described in more specifically with reference to FIG. 5 illustrating a more detailed configuration example of the image forming apparatus 100. As illustrated in FIG. 5, the image forming apparatus 100 includes the memory 130 in addition to the communication unit 110 and the processing unit 120 described above. The processing unit 120 includes the Web server 122. The memory 130 includes the Web page 132. By doing so, the user can browse the Web page 132 via the Web browser of the terminal apparatus 300. The Web page 132 displays, for example, network setting information and management information on consumables of the image forming apparatus 100. The consumables of the image forming apparatus 100 include, for example, a cable, ink, toner, and a lamp. The user may change various settings related to the image forming apparatus 100 by inputting operations such as changing a setting item displayed on the Web page 132.

In step S120, the server certificate SC is stored in the memory 130 as illustrated in FIG. 5. More specifically, the memory 130 includes a nonvolatile memory such as a flash memory, and the server certificate SC is stored in the nonvolatile memory in step S120. In this way, when the server certificate SC is updated, the processing unit 120 downloads the updated server certificate SC from the first server 200-1 to the memory 130. By doing so, the updated server certificate SC can be stored in the memory 130 of the image forming apparatus 100. Since the memory 130 here is a nonvolatile memory, for example, even when the image forming apparatus 100 is powered off, data on the downloaded server certificate SC will not be lost.

After executing step S120, the processing unit 120 restarts the image forming apparatus 100 (step S122). For example, the processing unit 120 functions as the Web server 122 by loading a program, data, and the like related to the Web server 122 into a volatile memory (not illustrated) that is a working memory. That is, at a time point when step S120 described above is executed, the updated server certificate SC is not loaded into the volatile memory, and thus the processing unit 120 cannot execute processing using the updated server certificate SC. Therefore, by restarting (step S122), data on the updated server certificate SC can be loaded into the volatile memory. In this way, in the image forming apparatus 100 according to the embodiment, when the server certificate SC is updated, the processing unit 120 downloads the updated server certificate SC from the first server 200-1 and restarts the image forming apparatus 100. By doing so, the processing unit 120 can cause the Web server 122 to function based on the updated server certificate SC.

Thereafter, the processing unit 120 transmits the acquired IP address and the host name information to the second server 200-2 (step S130). The server processing unit 220 of the second server 200-2 stores the IP address and the host name information in association with each other as registration information (step S200), and transmits the IP address and the host name information to the DNS server 400. Accordingly, the IP address and the host name information are stored in association with each other in a storage unit (not illustrated) of the DNS server 400.

Thereafter, when the user of the terminal apparatus 300 starts the Web browser and inputs host name information on the image forming apparatus 100 on the Web browser, the terminal apparatus 300 transmits a packet including the host name information to the DNS server 400 in order to request an IP address (step S300). The IP address of the DNS server 400 is set in the terminal apparatus 300 at the time of setting a network between the terminal apparatus 300 and the image forming apparatus 100. Then, the DNS server 400 transmits a response packet including the IP address corresponding to the received host name information to the terminal apparatus 300 (step S400).

The terminal apparatus 300 issues an HTTPS request to the communication unit 110 of the image forming apparatus 100 based on the acquired IP address (step S310). Accordingly, the processing unit 120 determines YES in step S140 in FIG. 2, and transmits a response packet including the server certificate SC to the terminal apparatus 300 (step S142). The response packet in step S142 includes a public key of the image forming apparatus 100.

The terminal apparatus 300 verifies the received server certificate SC using a root certificate (step S320). Then, in the verification (step S320), since the server certificate SC is updated, the image forming apparatus 100 and the terminal apparatus 300 start HTTPS communication in order to satisfy a requirement that an expiration date is not reached (step S150). Specifically, for example, the terminal apparatus 300 sets a common key, and encrypts the common key using a public key acquired from the image forming apparatus 100. Thereafter, the terminal apparatus 300 transmits an encrypted common key to the image forming apparatus 100. The image forming apparatus 100 decrypts the acquired common key using a private key held only by the image forming apparatus 100. Accordingly, the image forming apparatus 100 and the terminal apparatus 300 can share a common key that is not known to a third party. Accordingly, the image forming apparatus 100 and the terminal apparatus 300 establish HTTPS communication, which is bidirectional communication in which various types of information is encrypted, using the common key. In this way, in the image forming apparatus 100 according to the embodiment, the processing unit 120 performs HTTPS communication with the terminal apparatus 300 by transmitting the response packet including the server certificate SC to the terminal apparatus 300. By doing so, communication based on the HTTPS communication protocol can be performed between the image forming apparatus 100 and the terminal apparatus 300.

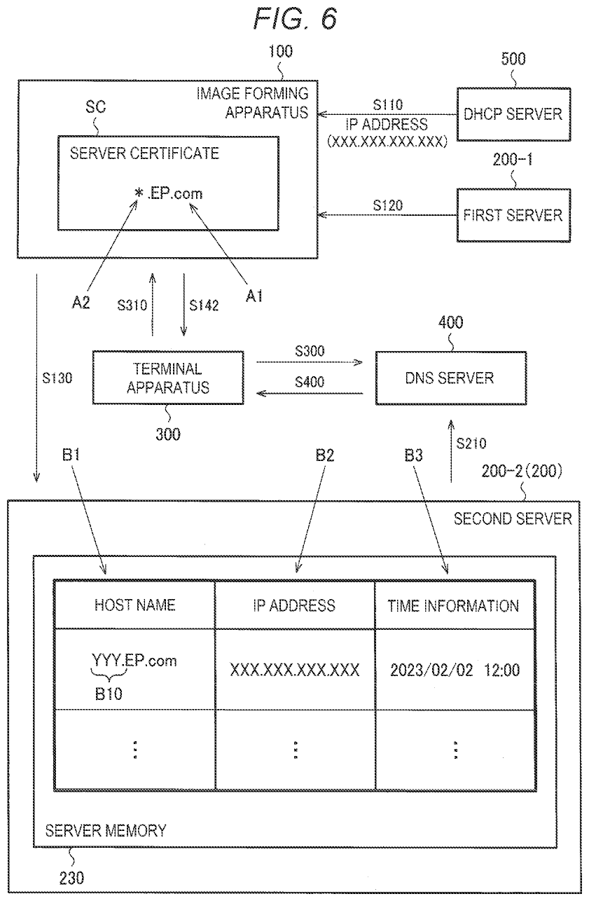

Step S110 described above may be implemented by acquiring an IP address using a dynamic host configuration protocol (DHCP), for example. For example, as illustrated in FIG. 6, in step S110 described above, as a predetermined timing, the processing unit 120 acquires an IP address from a DHCP server 500 at a timing when the image forming apparatus 100 is started. The DHCP server 500 may be arranged in the network to which the terminal apparatus 300 belongs. The IP address, the host name information, and the like illustrated in FIG. 6 are illustrated for convenience of description and are not related to actual ones.

Thereafter, in step S130, the host name information and the acquired IP address are transmitted to the second server 200-2. That is, in the image forming apparatus 100 according to the embodiment, the processing unit 120 acquires the IP address acquired from the DHCP server 500 when the image forming apparatus 100 is started, and transmits the host name information and the acquired IP address to the second server 200-2 via the communication unit 110. By doing so, a time from when the image forming apparatus 100 is started to when the image forming apparatus 100 and the terminal apparatus 300 become communicable with each other can be minimized. Accordingly, the user can quickly communicate with the image forming apparatus 100 via the terminal apparatus 300 after the image forming apparatus 100 is started.

The server certificate SC acquired by the image forming apparatus 100 according to the embodiment may be a wildcard certificate. That is, as illustrated in A1 in FIG. 6, the server certificate SC includes host name information, but an asterisk is designated for a subdomain indicated by A2 in the host name information. In this case, the same server certificate SC can be used for all servers that are different only in subdomains in the same layer as the asterisk. That is, in a case where a plurality of image forming apparatuses 100 are coupled to the first server 200-1, when the Web servers 122 have a common domain, each processing unit 120 may receive the same server certificate SC from the first server 200-1 in step S120. In this way, in the image forming apparatus 100 according to the embodiment, the processing unit 120 acquires a wildcard certificate as the server certificate SC from the first server 200-1 via the communication unit 110. By doing so, when the first server 200-1 is coupled to the plurality of image forming apparatuses 100, a burden of managing the server certificate SC can be reduced.

In the server memory 230 of the second server 200-2, the host name information indicated by B1 and the IP address indicated by B2 are stored in association with each other. The server memory 230 may also store time information stored as indicated by B3 in further association. In FIG. 6, a subdomain indicated by B10 is simply exemplified as “YYY”, and may include a large number of characters obtained by hashing identification information or the like on the image forming apparatus 100 with a predetermined hash function. Information such as the predetermined hash function is provided in an application program of the image forming apparatus 100 in the terminal apparatus 300. That is, when the identification information on the image forming apparatus 100 is acquired in advance, the terminal apparatus 300 can create the same host name information as the host name information in step S130 and S210, and execute step S300 based on the host name information. That is, in the embodiment, when the identification information on the image forming apparatus 100 is different, the subdomain indicated by B10 is different and host name information having a common domain is automatically generated with the predetermined hash function. Accordingly, the same host name information can be prevented from being associated with different IP addresses. In this way, in the image forming apparatus 100 according to the embodiment, the host name information includes the identification information on the image forming apparatus 100 and a domain name common to the plurality of image forming apparatuses 100. By doing so, HTTPS communication can be performed between the image forming apparatus 100 and the terminal apparatus 300 using the server certificate SC common to the image forming apparatuses 100.

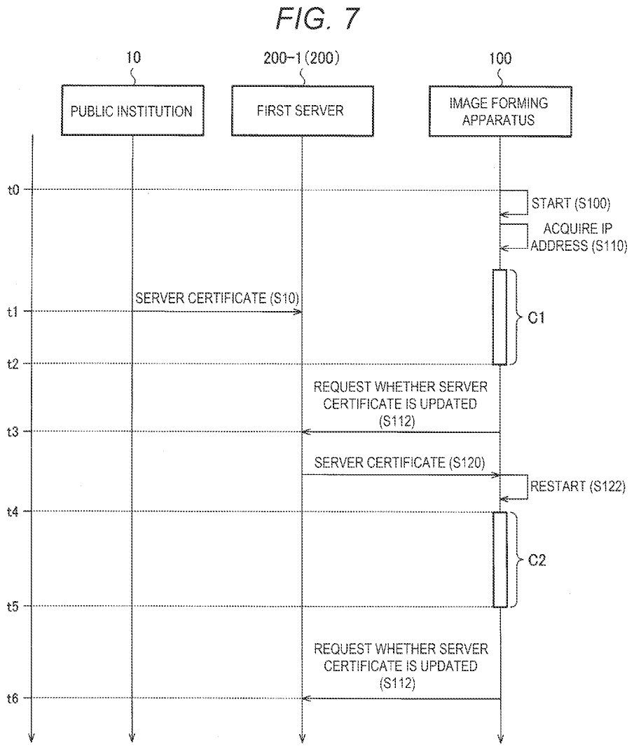

At a predetermined timing, the processing unit 120 may execute step S112 at a timing set by the user. For example, the user sets step S112 to be executed at a timing t3 and a timing t6 illustrated in FIG. 7. The timing t3 and the timing t6 in FIG. 7 are appropriately set in consideration of, for example, an operation state of the image forming apparatus 100, and timings for executing step S112 is not limited to twice, and step S112 may be executed three times or more after the image forming apparatus 100 is started.

In FIG. 7, for example, the image forming apparatus 100 is started at a timing to (step S100), and the processing unit 120 acquires an IP address (step S110). Thereafter, as indicated by C1, the image forming apparatus 100 operates continuously until a timing t2. In addition, the first server 200-1 acquires the server certificate SC at a timing t1 (step S10). The timing t1 is a timing after the timing to and before the timing t2.

Then, at the timing t3, the processing unit 120 requests the first server 200-1 whether the server certificate SC is updated (step S112), acquires the updated server certificate SC from the first server 200-1 (step S120), and restarts the image forming apparatus 100 (step S122). The timing t3 is a timing after the timing t2.

Thereafter, as indicated by C2, the image forming apparatus 100 operates continuously from a timing t4 to a timing t5. The timing t4 is a timing after the timing t3, and the timing t5 is a timing after the timing t4.

Then, at the timing t6, the processing unit 120 requests the first server 200-1 whether the server certificate SC is updated (step S112). The timing t6 is a timing after the timing t5. Since step S10 is not executed again during a period from the timing t1 to the timing t6 described above, for example, the first server 200-1 transmits a response packet including data indicating that update of the server certificate SC is unnecessary to the processing unit 120 in response to the request in step S112. Accordingly, the processing unit 120 does not execute step S120, and does not restart the image forming apparatus 100. Alternatively, the processing unit 120 may automatically execute step S120 corresponding to step S112 at the timing t6, and acquire the same server certificate SC as the server certificate SC based on the request made at the timing t3, but do not execute restarting (step S112) when the same server certificate SC is acquired.

As described above, in the image forming apparatus 100 according to the embodiment, the processing unit 120 transmits a request packet regarding whether the server certificate SC is updated to the first server 200-1 via the communication unit 110 at a timing set by the user (step S112). By doing so, the user can freely set the timing at which the image forming apparatus 100 acquires the updated server certificate SC. Accordingly, for example, the image forming apparatus 100 can be restarted at a timing at which the operation of the image forming apparatus 100 is not interfered.

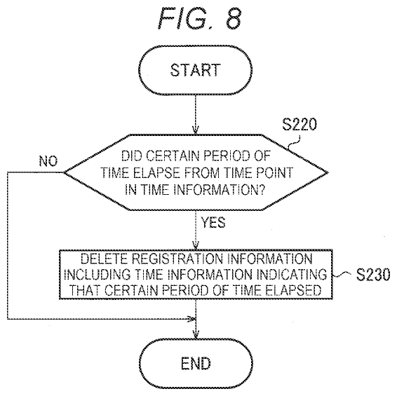

For example, the server processing unit 220 may further execute processing illustrated in a flowchart in FIG. 8 for each piece of registration information. The server processing unit 220 execute processing of determining whether a certain period of time elapsed from a time point in the time information indicated by B3 in FIG. 6 (step S220). When determining that the certain period of time elapsed (YES in step S220), the server processing unit 220 deletes the registration information including the time information indicating that the certain period of time elapsed (step S230). On the other hand, when it is determined that the certain period of time did not elapse (No in step S220), the flow ends. The certain period of time here is appropriately determined in consideration of a usage state of the terminal apparatus 300 or the like.

In this way, the server processing unit 220 according to the embodiment stores time information related to a timing at which the IP address and the host name information are transmitted from the image forming apparatus 100, and determines whether to delete the registered registration information based on the stored time information. By doing so, unnecessary registration information can be prevented from being accumulated in the second server 200-2. Accordingly, a burden on an administrator of the second server 200-2 to manage the second server 200-2 can be reduced.

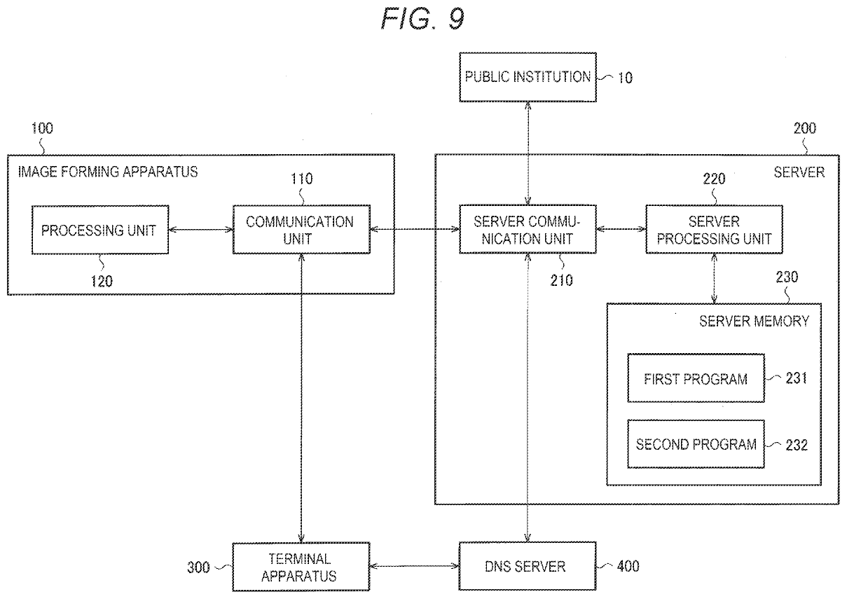

Although the first server 200-1 and the second server 200-2 are illustrated and described as separate hardware for convenience, the first server 200-1 and the second server 200-2 may function as one piece of hardware. Specifically, for example, as illustrated in FIG. 9, the server 200 may include the server communication unit 210, the server processing unit 220, and server memory 230 described above, and the image forming apparatus 100, the public institution 10, and the DNS server 400 may be coupled to the server 200 via the server communication unit 210. In this case, the server processing unit 220 functions as the first server 200-1 by reading a first program 231 from the server memory 230, and functions as the second server 200-2 by reading a second program 232 from the server memory 230. By doing so, the method according to the embodiment described above can be performed in the same manner.

As described above, the server 200 according to the embodiment includes the server communication unit 210 that communicates with the image forming apparatus 100, and the server processing unit 220 that manages the registration information in which the IP address of the image forming apparatus 100 and the host name information are associated with each other. The server processing unit 220 receives the host name information and the IP address via the server communication unit 210 from the image forming apparatus 100 that acquires the server certificate SC created based on the host name information, and manages the registration information based on the received host name information and IP address. By doing so, the server 200 can manage the host name information and the IP address as the registration information from the image forming apparatus 100 that acquires the updated server certificate SC. Accordingly, the server 200 can perform HTTPS communication between the terminal apparatus 300 and the image forming apparatus 100 by transmitting the IP address to the terminal apparatus 300 in response to a request from the terminal apparatus 300. Accordingly, as described above, HTTPS communication can be performed between the image forming apparatus 100 and the terminal apparatus 300 without a burden on the user to manage the expiration date of the server certificate SC. Accordingly, convenience of the image forming apparatus 100 can be improved.

As described above, an image forming apparatus according to the embodiment includes a communication unit configured to communicate with a first server that periodically updates a server certificate and a second server that manages registration information in which an IP address and host name information are associated with each other, and a processing unit. The processing unit acquires the server certificate created based on the host name information from the first server via the communication unit, and transmits the host name information and the IP address of the image forming apparatus to the second server via the communication unit. When receiving a communication request packet from a terminal apparatus that acquires the IP address based on the registration information, the processing unit performs HTTPS communication with the terminal apparatus using the server certificate.

By doing so, the processing unit can receive a request from the terminal apparatus that acquires, from the second server, the IP address associated with the host name information. Accordingly, the image forming apparatus that acquires the updated server certificate SC can perform HTTPS communication with the terminal apparatus. Accordingly, HTTPS communication can be performed between the image forming apparatus and the terminal apparatus without a burden on the user to manage an expiration date of the server certificate. Accordingly, convenience of the image forming apparatus 100 can be improved.

The processing unit may acquire a wildcard certificate as the server certificate from the first server via the communication unit.

By doing so, when the first server is coupled to a plurality of image forming apparatuses, a burden of managing the server certificate can be reduced.

The host name information may include identification information on the image forming apparatus and a domain name common to a plurality of image forming apparatuses.

By doing so, HTTPS communication can be performed between the image forming apparatus and the terminal apparatus using the server certificate common to the image forming apparatuses.

The processing unit may perform HTTPS communication with the terminal apparatus by transmitting a response packet including the server certificate to the terminal apparatus.

By doing so, communication based on an HTTPS communication protocol can be performed between the image forming apparatus and the terminal apparatus.

The processing unit may also update the server certificate at a predetermined timing.

By doing so, a burden on the user to manually update the server certificate can be eliminated.

The processing unit may transmit a request packet regarding whether the server certificate is updated to the first server via the communication unit at a timing when the image forming apparatus is started and the IP address of the image forming apparatus is acquired.

By doing so, the server certificate can be updated when the image forming apparatus is started.

The processing unit may transmit a request packet regarding whether the server certificate is updated to the first server via the communication unit at a timing set by the user.

By doing so, the user can freely set the timing at which the image forming apparatus acquires the updated server certificate.

When the server certificate is updated, the processing unit may download the updated server certificate from the first server to a memory.

By doing so, the updated server certificate can be stored in the memory of the image forming apparatus.

When the server certificate is updated, the processing unit may download the updated server certificate from the first server and restart the image forming apparatus.

By doing so, the processing unit can cause a Web server to function based on the updated server certificate.

The processing unit may acquire the IP address acquired from a DHCP server when the image forming apparatus is started, and transmit the host name information and the acquired IP address to the second server via the communication unit.

By doing so, a time from when the image forming apparatus is started to when the image forming apparatus and the terminal apparatus become communicable with each other can be minimized.

A processing method according to the embodiment includes processing of communicating with a first server that periodically updates a server certificate and a second server that manages registration information in which an IP address and host name information are associated with each other, and processing of acquiring the server certificate created based on the host name information from the first server. The processing method according to the embodiment further includes processing of transmitting the host name information and the IP address of the image forming apparatus to the second server, and processing of, when receiving a communication request packet from a terminal apparatus that acquires the IP address based on the registration information, performing HTTPS communication with the terminal apparatus using the server certificate.

There is provided a non-transitory computer-readable storage medium storing a program according to the embodiment, the program causing a computer to function as a communication unit configured to communicate with a first server that periodically updates a server certificate and a second server that manages registration information in which an IP address and host name information are associated with each other, and a processing unit. The processing unit acquires the server certificate created based on the host name information from the first server via the communication unit, and transmits the host name information and the IP address of the image forming apparatus to the second server via the communication unit. When receiving a communication request packet from a terminal apparatus that acquires the IP address based on the registration information, the processing unit performs HTTPS communication with the terminal apparatus using the server certificate.

A server according to the embodiment includes a server communication unit configured to communicate with an image forming apparatus, and a server processing unit configured to manage registration information in which an IP address of the image forming apparatus and host name information are associated with each other. The server processing unit receives the host name information and the IP address via the server communication unit from the image forming apparatus that acquires a server certificate created based on the host name information, and manages the registration information based on the received host name information and IP address.

The server processing unit may store time information related to a timing at which the IP address and the host name information are transmitted from the image forming apparatus, and determine whether to delete the registered registration information based on the stored time information.

By doing so, unnecessary registration information can be prevented from being accumulated in the second server.

Although the embodiment has been described in detail above, it can be easily understood by those skilled in the art that many modifications can be made without substantially departing from the novel matters and effects of the embodiment. Accordingly, all such modifications are within the scope of the present disclosure. For example, a term described at least once together with a different term having a broader meaning or the same meaning in the description or the drawings can be replaced with the different term at any place in the description or the drawings. All combinations of the embodiment and the modifications are also within in the scope of the present disclosure. The configurations and operations of the image forming apparatus, the processing method, the program, the server, and the like are not limited to those described in the embodiment, and various modifications are can be made.

What is claimed is:

1. An image forming apparatus comprising:
a communication unit configured to communicate with a first server that periodically updates a server certificate and a second server that manages registration information in which an IP address and host name information are associated with each other; and
a processor, wherein
the processor
acquires the server certificate created based on the host name information from the first server via the communication unit,
transmits the host name information and the IP address of the image forming apparatus to the second server via the communication unit, and
when receiving a communication request packet from a terminal apparatus that acquires the IP address based on the registration information, performs HTTPS communication with the terminal apparatus using the server certificate.

2. The image forming apparatus according to claim 1, wherein
the processor acquires a wildcard certificate as the server certificate from the first server via the communication unit.

3. The image forming apparatus according to claim 1, wherein
the host name information includes identification information on the image forming apparatus and a domain name common to a plurality of image forming apparatuses.

4. The image forming apparatus according to claim 1, wherein
the processor performs HTTPS communication with the terminal apparatus by transmitting a response packet including the server certificate to the terminal apparatus.

5. The image forming apparatus according to claim 1, wherein
the processor updates the server certificate at a predetermined timing.

6. The image forming apparatus according to claim 1, wherein
the processor transmits a request packet regarding whether the server certificate is updated to the first server via the communication unit at a timing when the image forming apparatus is started and the IP address of the image forming apparatus is acquired.

7. The image forming apparatus according to claim 1, wherein
the processor transmits a request packet regarding whether the server certificate is updated to the first server via the communication unit at a timing set by a user.

8. The image forming apparatus according to claim 1, wherein
when the server certificate is updated, the processor downloads the updated server certificate from the first server to a memory.

9. The image forming apparatus according to claim 1, wherein
when the server certificate is updated, the processor downloads the updated server certificate from the first server and restart the image forming apparatus.

10. The image forming apparatus according to claim 1, wherein
the processor acquires the IP address acquired from a DHCP server when the image forming apparatus is started, and transmits the host name information and the acquired IP address to the second server via the communication unit.

11. A processing method comprising:
processing of communicating with a first server that periodically updates a server certificate and a second server that manages registration information in which an IP address and host name information are associated with each other;
processing of acquiring the server certificate created based on the host name information from the first server;
processing of transmitting the host name information and the IP address of the image forming apparatus to the second server; and
processing of, when receiving a communication request packet from a terminal apparatus that acquires the IP address based on the registration information, performing HTTPS communication with the terminal apparatus using the server certificate.

12. A non-transitory computer-readable storage medium storing a program causing a computer to function as:
a communication unit configured to communicate with a first server that periodically updates a server certificate and a second server that manages registration information in which an IP address and host name information are associated with each other, and a processor, wherein
the processor
acquires the server certificate created based on the host name information from the first server via the communication unit,
transmits the host name information and the IP address of the image forming apparatus to the second server via the communication unit, and
when receiving a communication request packet from a terminal apparatus that acquires the IP address based on the registration information, performs HTTPS communication with the terminal apparatus using the server certificate.

13. A server comprising:
a server communication unit configured to communicate with an image forming apparatus;
a server processor configured to manage registration information in which an IP address of the image forming apparatus and host name information are associated with each other, wherein
the server processor receives the host name information and the IP address via the server communication unit from the image forming apparatus that acquires a server certificate created based on the host name information, and manages the registration information based on the received host name information and IP address.

14. The server according to claim 13, wherein
the server processor stores time information related to a timing at which the IP address and the host name information are transmitted from the image forming apparatus, and determines whether to delete the registered registration information based on the stored time information.
